(19) United States
(12) Patent Application Publication
(10) Pub. No.: US 2014/0341692 A1
(43) Pub. Date: Nov. 20, 2014

(54) Machine For Stacking Bales

(71) Applicant: ARCUSIN, S.A., Vila-Sana (ES)

(72) Inventor: Manuel CUSINE BARBER, Vila-Sana (ES)

(73) Assignee: ARCUSIN, S.A., Vila-Sana (ES)

(21) Appl. No.: 14/278,834

(22) Filed: May 15, 2014

(30) Foreign Application Priority Data
May 15, 2013 (EP) 13382180

(51) Int. Cl. A01D 85/00; A01D 90/02

(52) U.S. Cl. CPC A01D 85/005; A01D 90/02
USPC 414/789.7

(57) ABSTRACT

A hay bale accumulator comprising a frame configured to be towed and positioned over a hay bale resting on the ground, said frame defining a bale holding compartment comprising means for holding and vertically lifting a bale, wherein said means for vertically lifting the bale include at least one pair of vertical slide carriages of said bale holding means, said carriages being disposed in opposition to each other on the sides of said bale holding compartment, said bale holding means comprising at least two gripping arms, each of which is joined in an articulated manner to each of said slide carriages, said arms being susceptible of being extended to come into contact with said bale when said bale enters the interior of said compartment, the accumulator further comprising means for suspending said bale in said upper stacking position in the interior of said compartment while said carriages move towards a lower loading position to receive a new bale in the same compartment, said gripping arms being susceptible of being retracted to free the entrance of said compartment to receive said new bale while said slide carriages remain on standby in the lower loading position.

The present invention relates to a hay bale accumulator, specifically a machine for vertically stacking hay bales.

### BACKGROUND OF THE INVENTION

Accumulators that group hay bales to facilitate handling or transport thereof from the field to a storage location are available in the market. However, most of these accumulators are destined for grouping small prismatic bales.

In order to group large prismatic bales, there are accumulators that comprise a horizontal platform whereon three bale packages are formed, which is then tilted to deposit and unload the three packages onto the ground. These accumulators have the drawback of being complicated to handle, as the horizontal platform requires a large amount of space.

Patent DE19954487 discloses a large prismatic bale accumulator having the advantage over the other accumulators in the market that it dispenses with the aforementioned horizontal platform and is capable of vertically stacking the bales by lifting them directly off the ground.

The accumulator of the aforementioned patent DE19954487 comprises a frame configured to be towed and positioned over a hay bale resting on the ground in a field. This frame includes a clamp for holding and vertically lifting the bale from a lower stacking position to an upper stacking position. Once the bale is disposed in this upper stacking position, the accumulator moves until the frame is positioned over a new bale, in such a manner that the bale suspended by the clamp can be deposited on top of the new bale so as to form a stack.

However, it has been proven that the accumulator of the aforementioned patent has several drawbacks. One of said drawbacks lies in the fact that it works at a very slow rate, as the accumulator must stop over an incoming bale long enough for the clamp's gripping arms to descend and grip the bale. Also, in many cases the tractor operator must have sufficient expertise to ensure that the bale entering the frame is centered with respect to the clamp's arms, as otherwise the bale itself will prevent the clamp from descending to the loading position. This results in a slower work pace, which negatively affects accumulator performance.

### DESCRIPTION OF THE INVENTION

The objective of the present invention is to resolve the aforementioned drawbacks by developing an accumulator for grouping small or large hay bales which has the following advantages.

In accordance with this objective, the present invention provides a hay bale accumulator comprising a frame configured to be towed and positioned over a hay bale resting on the ground, said frame defining a bale holding compartment comprising means for holding and vertically lifting a bale, wherein said means for vertically lifting the bale include at least one pair of vertical slide carriages of said bale holding means, said carriages being disposed in opposition to each other on the sides of said bale holding compartment, said bale holding means comprising at least two gripping arms, each of which is joined in an articulated manner to each of said slide carriages, said arms being susceptible of being extended to come into contact with said bale when said bale enters the interior of said compartment, the accumulator further comprising means for suspending said bale in said upper stacking position in the interior of said compartment while said carriages move towards a lower loading position to receive a new bale in the same compartment, said gripping arms being susceptible of being retracted to free the entrance of said compartment to receive said new bale while said slide carriages remain on standby in the lower loading position.

The accumulator of the present invention has the advantage over the other accumulators in the state of the art that it allows vertical stacking of the bales, lifting them directly off the ground at a very fast work pace, without need to stop the accumulator or without need to use an intermediate horizontal platform.

In the accumulator of the present invention, the carriages that include the means for holding the bales are disposed in opposition to each other on the sides of a bale holding compartment awaiting an incoming bale. As a result, when the frame is disposed over a hay bale, the holding means act almost immediately, gripping the bale and moving it vertically to the upper stacking position where the bale is suspended.

Therefore, as opposed to the accumulator of patent application DE19954487, in the accumulator claimed the carriages do not have to ascend to an upper position to allow entry of a bale nor do they subsequently have to descend to a lower position in order to hold and lift the same bale, but rather said carriages can wait for a bale, without interfering with the entry thereof in the compartment.

Additionally, in the present invention the carriages can descend to the lower loading position in order to hold and lift the last incoming bale while the previously loaded bale remains suspended.

In the accumulator of patent DE19954487, this stacking process is not possible, as there are no means for suspending the bales and when the carriages are in a lower loading position, the carriages themselves will prevent the entry of a new bale in the compartment.

The gripping arms have the peculiarity that they are retracted to free the entrance and are extended to come into contact with the bale when said bale enters the compartment.

These gripping arms are configured in the manner of clamps and can optionally include spikes that are introduced or driven into the bale to hold it.

According to the same embodiment, the means for suspending the bale in the upper stacking position comprise at least two grasping arms joined in an articulated manner to structures on the sides of the bale holding compartment of said frame, said arms being susceptible of being extended to grasp said bale when said bale is in the upper stacking position.

Also according to the same embodiment, said accumulator comprises at least one pair of slide rails of said carriages vertically disposed in opposition to each other on the structures on the sides of said compartment, said rails allowing said carriages to move from said lower loading position to said upper stacking position and vice versa.

Therefore, as opposed to the accumulators of the state of the art, the weight of the stack rests on the structures on the sides of the compartment. In the accumulator of DE19954487, the weight of the stack is cantilevered, making it more unstable.

Also, this configuration with lateral carriage slide rails has the advantage over the accumulator of DE19954487 that it considerably reduces total accumulator height, as the carriages can be disposed at a lower height without interfering with the entry of the bale.

Preferably, the accumulator comprises a rear stopper to hold the bales in the interior of said compartment while said accumulator is towed by a tractor and, advantageously, said rear stopper includes at least one door that is joined in an articulated manner to the exit of said compartment, said door being susceptible of being opened to release a stack of bales from the interior of said compartment while said accumulator is being towed by the tractor.

This rear stopper pushes the incoming bale to the interior of the compartment, dragging it along the ground long enough for the bale to be held by the carriage gripping arms. When the stack is unloaded, the door opens to release the load. Therefore, the stacking process can be carried out in a continuous manner without need to stop the tractor, thereby improving performance.

Preferably, the accumulator comprises a draw bar to join said frame to the drive train of said tractor in an articulated manner, said accumulator being susceptible of being misaligned with respect to the tractor to facilitate the entry of a bale in the interior of said compartment.

Advantageously, said frame comprises a structure disposed in a bridge-like manner between the structures on the sides of said compartment, said structure determining the upper limit of the entry to said compartment in a bridge-like manner.

Preferably, said accumulator comprises means for guiding the bales on entering the bale holding compartment of the frame.

According to one embodiment, said bale guiding means comprise a pair of guides disposed horizontally on either side of said compartment and, optionally, at least a second guide that projects from the compartment to guide the bales to the entrance of the compartment while the accumulator is being towed by the tractor.

This second guide could be disposed, for example, on the draw bar that joins the frame to the tractor.

The aforementioned guides facilitate the entry and correct positioning of the bale in the interior of the compartment while the accumulator is being towed by the tractor, allowing a very fast work pace.

The accumulator of the present invention is specially designed to collect and vertically stack large hay bales directly from the field or meadow where the bales are resting. As a result, the accumulator dispenses with horizontal or intermediate loading platforms, due to which it is very simple and easy to operate. In addition, the vertical stacking facilitates subsequent loading onto trailers or trucks.

Additionally, this accumulator works at a very fast pace in the field, as the stacks are formed and unloaded continuously while being towed and the frame being positioned consecutively over the hay bales resting in the field.

Further, the guides that guide the bales allow the loading operation to always be carried out ensuring the correct position of the bale package and, thus, stack stability.

### BRIEF DESCRIPTION OF THE DRAWINGS

In order to better understand the foregoing, drawings have been attached where an embodiment has been represented schematically and by way of non-limiting example:

FIG. 1 shows an elevational view of one side of the accumulator.

FIG. 2 shows a top plan view of the accumulator of FIG. 1.

FIG. 3 shows a perspective view of the rear of the accumulator of FIG. 1.

FIGS. 4 to 8 show various perspective and elevational views of the loading cycle of a stack formed by the accumulator of FIG. 1.

FIG. 9 shows a perspective view of the accumulator during unloading of a stack.

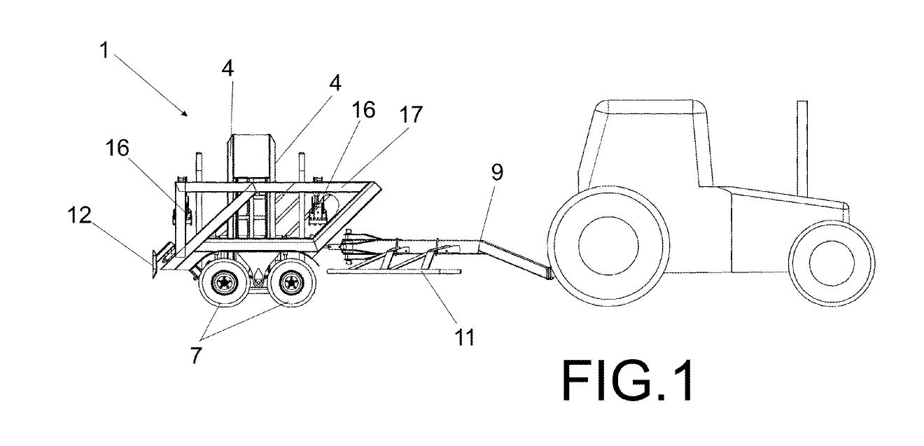

### DESCRIPTION OF A PREFERRED EMBODIMENT

Following is a description of the accumulator 1 of the present invention, making reference to the foregoing figures.

The accumulator 1 claimed includes a frame 2 configured to be towed and positioned over a hay bale 3 resting directly on the ground in a field.

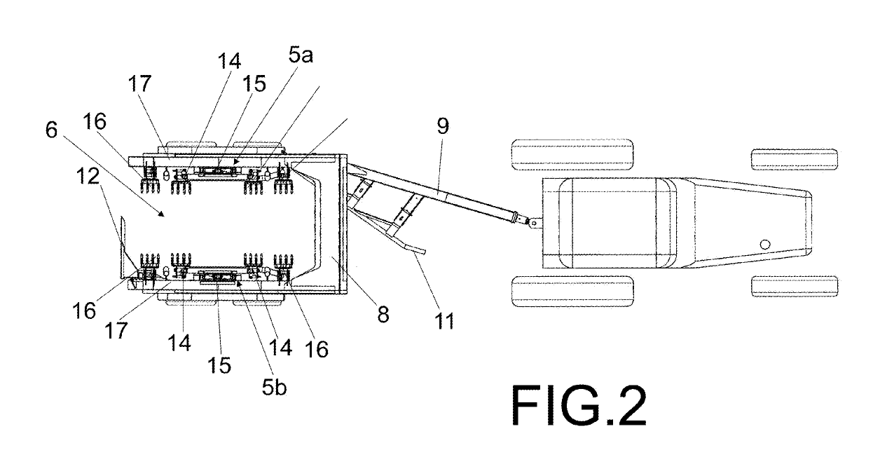

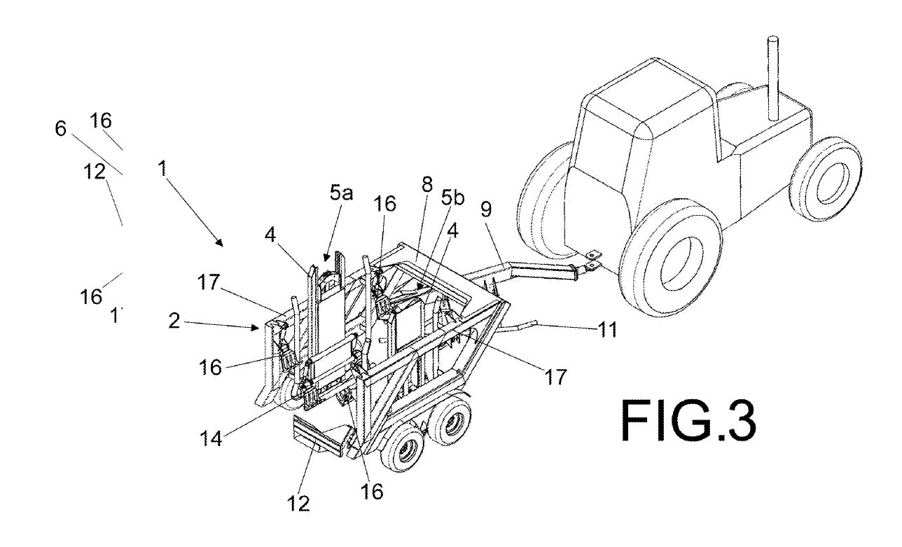

The frame 2 includes a pair of carriage 5a, 5b slide guides 4 vertically disposed in opposition to each other on the sides of a bale 3 holding compartment 6 of the frame 2. In the embodiment described, the guides 4 are disposed in opposition to structures on the sides 17 of the compartment 6 that rest on the drive train of the wheels 7. As can be observed in FIG. 2, these wheels 7 and the carriages 5a, 5b are disposed centered in an intermediate position that facilitates the load balancing of the structures 17 on the sides of the frame 2.

The same frame 2 comprises a structure 8 disposed in a bridge-like manner between the structures 17 on the sides of the compartment 6. This structure 8 defines the upper limit of the entrance of the bale 3 holding compartment 6.

The frame 2 is joined to the drive train of a tractor in an articulated manner by means of a draw bar 9. In this manner, the operator can misalign the accumulator 1 with respect to the tractor in a working position that facilitates the entry of the bales 3 in the interior of the compartment 6.

The sides of the bale 3 holding compartment 6 of the frame 2 include horizontally disposed guides 10 for positioning the bales 3. As can be observed in the top plan view of FIG. 2, in addition to the guides 10 of the interior of the compartment 6, the accumulator 1 includes a second guide 11 that projects from the compartment 6 to guide the bales 2 towards the entrance while the accumulator 1 is being towed by the tractor.

A swinging door 12 has been envisaged at the rear of the compartment 6 of the frame 2 which acts as a rear stopper when closed in order to grasp the bales 3 in the interior of the compartment 6 while the accumulator 1 is being towed by the tractor.

This door 12 is joined in an articulated manner to the exit of the compartment 6 and is actuated by a fluid dynamic cylinder to allow the exit and unloading of the bales 3 that form the stack 13.

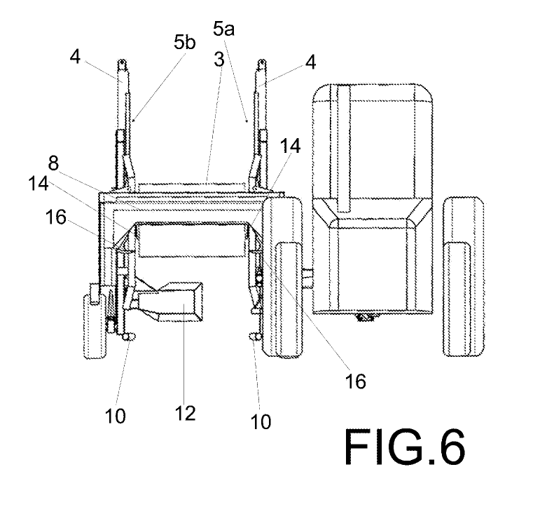

The bale 3 holding means are joined to the slide carriages 5a, 5b. In the embodiment being described, these holding means are configured by two gripping arms 14 which can move simultaneously on actuating the carriages 5a, 5b in order to hold and lift a bale 3 in the interior of the compartment 6. The carriages 5a, 5b are actuated by means of a pair of fluid dynamic cylinders 15 mounted on the slide rails 4 of the carriages 5a, 5b. The gripping arms 14 are joined to their respective carriage 5a, 5b in an articulated manner in such a manner that they are susceptible of being extended to come into contact with a bale 3 when said bale 3 is in the interior of the compartment 6 (see FIG. 6).

As already mentioned in the description of the invention, the accumulator 1 comprises means for suspending a bale 3 in the upper stacking position while the carriages 5a, 5b move towards a lower stacking position to receive a new bale 3.

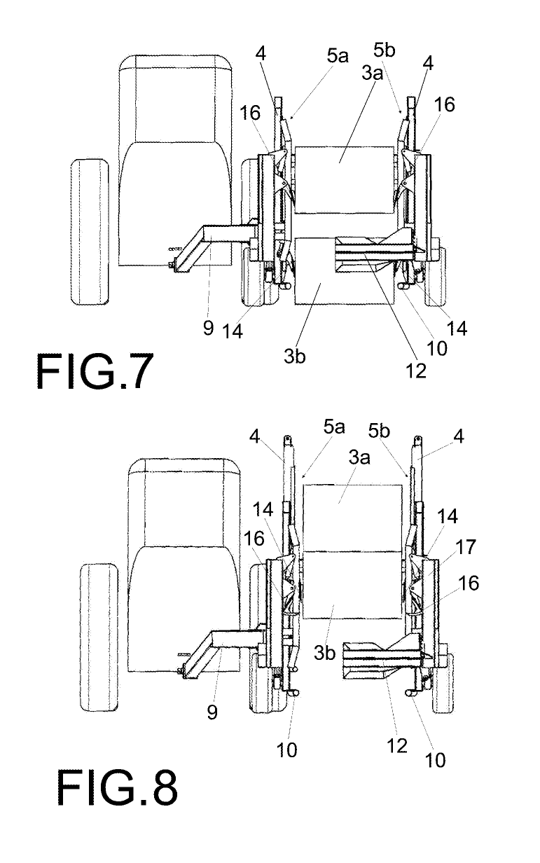

These suspension means are configured by two grasping arms 16 joined in an articulated manner to the structures on the sides 17 of the frame 2 and are susceptible of being extended to hold a bale 3 in the aforementioned upper stacking position see FIG. 7.

In the embodiment being described, both the gripping arms 14 and the grasping arms 16 are configured in the manner of a clamp. However, these arms 14, 16 can be configured, for example, in the manner of spikes or other type of appropriate means for holding the bales 3.

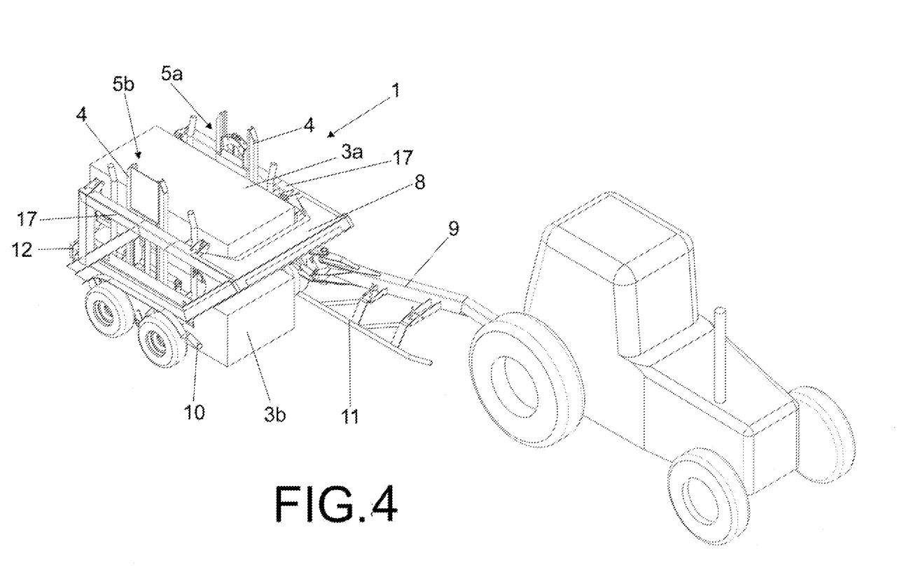

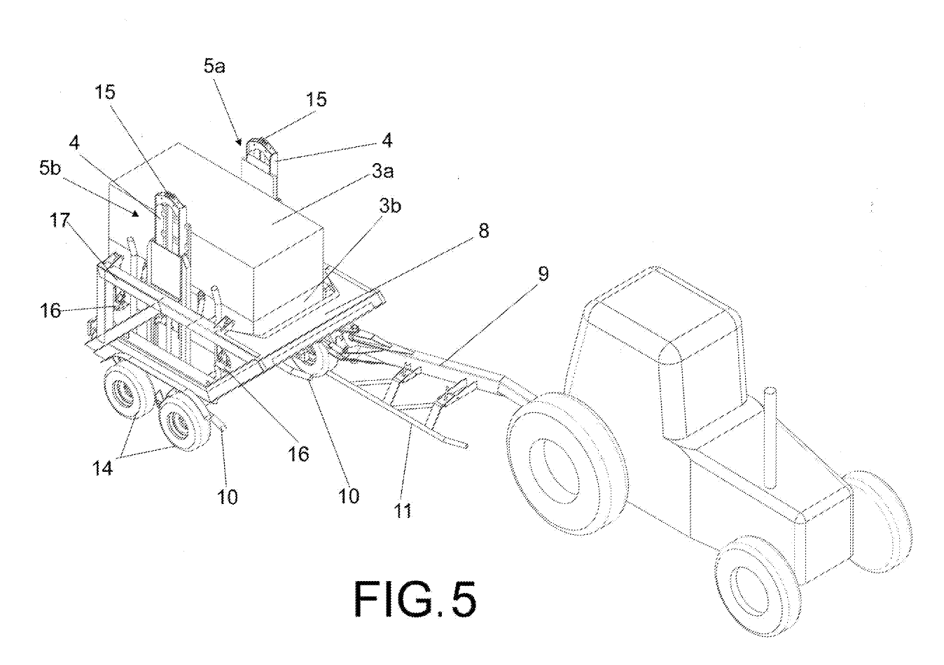

Following is a description of the operation of the accumulator 1, making reference to FIGS. 4 to 9, which describe a loading and unloading cycle of the accumulator 1.

The accumulator 1 moves along the road completely aligned with the tractor. On arriving at the field, the frame 2 moves by means of the draw bar 9 to adopt a working position wherein it becomes misaligned in order to facilitate the entry of the bales 3 in the interior of the compartment 6 of the frame 2.

As the accumulator 1 moves forward and encounters the first bale 3a which is resting on the ground in the field, the guides 10, 11 guide the bale 3a to position it in the interior of the compartment 6, until stopping against the swinging door 12 located at the rear of the compartment 6.

While the accumulator 1 moves forward, the bale 3a is grasped momentarily in the interior of the compartment 6 by the door 12 which acts as a rear stopper. Simultaneously, the gripping arms 14 are vertically extended so that they come into contact with the bale 3a to hold it. Next, the carriages 5a, 5b are simultaneously actuated to vertically move the gripping arms 14 in order to lift the bale 3a to a predetermined upper stacking position. In this position, the grasping arms 14 can descend to the lower loading position to await a new bale 3b.

Next, without stopping the accumulator 1, the frame 2 moves over a second bale 3b that enters the compartment 6 and is positioned beneath the first bale 3a, which is suspended in the upper stacking position.

FIG. 7 shows this upper stacking position wherein the first bale 3a is suspended by the grasping arms 16 of the structures on the sides 17 of the frame 2, while the gripping arms 14 hold a new bale 3b disposed at the lower loading position of the compartment 6.

Once the second bale 3b is held in place, the carriages 5a, 5b ascend to approximate the second bale 3b to the first bale 3a and form a stack 13. Next, the grasping arms 16 are extended to deposit the first bale 3a on top of the second bale 3b. In this position, the first bale 3a rests on the second bale 3b, forming a stack 13 so that the arms 14 of the carriages 5a, 5b can descend to the lower loading position (see FIG. 8).

At this point, without stopping the accumulator 1, the operator may choose between releasing the stack 13 of the two bales 3a, 3b and opening the door 12 or starting a new loading cycle, collecting a third bale 3c located inside the compartment 6. In this second case, the operator must move the carriages 5a, 5b to the upper position, raising the stack 13 and then actuating the grasping arms 16 to hold the stack 13 and release the gripping arms 14 so that these can descend to the lower position to deliver a new bale 3c.

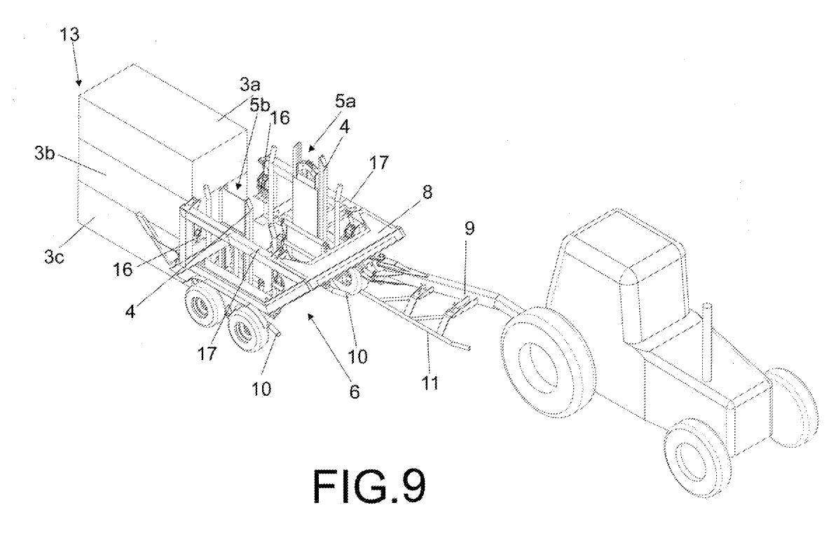

FIG. 9 shows the unloading of a stack 13 of three bales 3a, 3b, 3c formed in the interior of the compartment 6. When the accumulator 1 is in the forward position and the bale 3 package of the stack 13 is stopped on the ground, the load is automatically evacuated.

In order to unload the stack 13 on a nearby path or in a specific loading area, the accumulator 1 is transferred to the desired unloading place with the load suspended in its interior.

Despite the fact that reference has been made to a specific embodiment of the invention, it is evident to a person skilled in the art that the described accumulator 1 is susceptible of numerous variations and modifications, and that all the aforementioned details may be substituted for other, technically equivalent ones without detracting from the scope of protection defined by the attached claims.

1. A hay bale accumulator comprising a frame configured to be towed and positioned over a hay bale resting on the ground, said frame defining a bale holding compartment comprising means for holding and vertically lifting a bale, wherein said means for vertically lifting the bale include at least one pair of vertical slide carriages of said bale holding means, said carriages being disposed in opposition to each other on the sides of said bale holding compartment, said bale holding means comprising at least two gripping arms, each of which is joined in an articulated manner to each of said slide carriages, said gripping arms being susceptible of being extended to come into contact with said bale when said bale enters the interior of said compartment, the accumulator further comprising means for suspending said bale in said upper stacking position in the interior of said compartment while said carriages move towards a lower loading position to receive a new bale in the same compartment, the gripping arms being susceptible of being retracted to free the entrance of said compartment to receive said new bale while said slide carriages remain on standby in the lower loading position.

2. Accumulator, according to claim 1, wherein said means for suspending the bale in the upper stacking position comprise at least two grasping arms joined in an articulated manner on the sides of the bale receiving compartment of said frame, said grasping arms being susceptible of being extended to come into contact with said bale when said bale is in the upper stacking position.

3. Accumulator, according to claim 1, comprising at least one pair of slide rails of said carriages, vertically disposed in opposition to each other on the structures on the sides of said compartment, said rails allowing said carriages to move from said lower loading position to said upper stacking position and vice versa.

4. Accumulator, according to claim 1, comprising a rear stopper to grasp the bales in the interior of said compartment while said accumulator is towed by a tractor.

5. Accumulator, according to claim 4, wherein said rear stopper includes at least one door joined in an articulated manner to the exit of said compartment, said door being susceptible of being opened to release a stack of bales from the interior of said compartment while said accumulator is being towed by the tractor.

6. Accumulator, according to claim 1, comprising a draw bar to join said frame to the tractor's drive train in an articulated manner, said accumulator being susceptible of becoming misaligned with respect to the tractor to facilitate the entry of a bale in the interior of said compartment.

7. Accumulator, according to claim 2, wherein said frame comprises a structure disposed in a bridge-like manner between the structures on the sides of said compartment, said structure determining the upper limit of the entrance of said compartment in a bridge-like manner.

8. Accumulator, according to claim 1, comprising means for guiding the bales to the entrance of said compartment.

9. Accumulator, according to claim 8, wherein said means for guiding the bales comprise a pair of guides horizontally disposed on either side of said compartment.

10. Accumulator, according to claim 8, wherein said means for guiding the bales comprise at least one guide that projects from the compartment for guiding the bales towards the entrance while the accumulator is being towed by the tractor.
